(19) United States
(12) Patent Application Publication
(10) Pub. No.: US 2014/0170514 A1
(43) Pub. Date: Jun. 19, 2014

(54) VARIABLE PEM FUEL CELL SYSTEM START TIME TO OPTIMIZE SYSTEM EFFICIENCY AND PERFORMANCE

(71) Applicant: GM GLOBAL TECHNOLOGY OPERATIONS LLC, Detroit, MI (US)

(72) Inventors: Daniel I. HARRIS, Honeoye Falls, NY (US); Loren DEVRIES, Ionia, NY (US); Charles MACKINTOSH, Victor, NY (US); John P. SALVADOR, Penfield, NY (US); Derek S. KILMER, Pittsford, NY (US)

(73) Assignee: GM GLOBAL TECHNOLOGY OPERATIONS LLC, Detroit, MI (US)

(21) Appl. No.: 13/717,434

(22) Filed: Dec. 17, 2012

(51) Int. Cl. H01M 8/04

(52) U.S. Cl. CPC H01M 8/04223
USPC 429/429

(57) ABSTRACT

A system and method for controlling a fuel cell system start time based on various vehicle parameters. The method includes providing a plurality of inputs that identify operating conditions of the fuel cell system and determining a maximum allowable start-time of the fuel cell system using a hybridization control strategy and the plurality of inputs. The method then determines a maximum compressor speed and ramp rate to provide the optimal allowable start-time of the fuel cell system minimizing energy consumption and noise.

### BACKGROUND OF THE INVENTION

1. Field of the Invention

This invention relates generally to a system and method for optimizing a start time of a fuel cell system and, more particularly, to a system and method for optimizing a start time of a fuel cell system on a vehicle so as to reduce compressor parasitic losses and compressor noise, where the method considers various system data, such as brake pedal position, accelerator pedal position, gear selector position, ignition key position, vehicle speed, etc.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

During normal operation of a fuel cell system, various parasitic losses reduce system efficiency. These losses include diffusion of hydrogen from the anode compartment to the cathode compartment, electrical short-circuiting and ancillary power consumption from, for example, pumps, compressor, etc. For example, when the fuel cell system is in an idle mode, such as a fuel cell vehicle being stopped at a stop light, where the fuel cell stack is not generating power to operate system devices, cathode air and hydrogen gas are still being provided to the fuel cell stack, and the stack is generating output power. Operating a fuel cell system when in idle mode is generally inefficient because the afterformentioned losses exist while little to no energy is required for vehicle tractive power.

When electrical power is not required from the fuel cell system, the parasitic losses can be reduced by reducing the flow of reactants to the fuel cell system. More particularly, under certain fuel cell system operating conditions, it may be desirable to put the system in a stand-by mode where the system is consuming little or no power, the quantity of fuel being used is minimal and the system can quickly restart from the stand-by mode to provide increased power requests so as to increase system efficiency and reduce system degradation.

When a fuel cell vehicle is started from a key-off mode or a stand-by mode, the system control typically fills the anode side of the fuel cell stack with hydrogen and simultaneously spins up the cathode compressor to a desired speed to provide air to the cathode side of the stack. After reactant flows have been restored, normal system operation can resume and the fuel cell system can supply vehicle power loads. The time delay until the stack can provide the requested power depends on the transport delay to supply air to the cathode side of the stack. Therefore, the time from when the fuel cell vehicle can be driven when it is started depends on how fast the compressor responds. However, having a fast compressor speed ramp rate and/or high targeted compressor speed in order to have a shorter system start time requires more compressor parasitic power and more compressor and airflow noise.

As mentioned, in order to quickly start the fuel cell system, such as, for example, leaving a stop light from the stand-by mode, air must be supplied at a high flow rate from the compressor to the cathode compartment. The compressor's electrical power required for start-up is inversely proportional to restart time. For fast starts, significant power is required, and vehicle fuel efficiency is affected due to the inefficiency of the compressor at high power. For highly efficient operation, slow starts are required which may affect customer satisfaction in some driving situations. The current operational strategy requires a compromise of both start time and vehicle efficiency where the target compressor speed, speed ramp rate and start time is defined by a calibration.

### SUMMARY OF THE INVENTION

In accordance with the teachings of the present invention, a system and method are disclosed for controlling a fuel cell system start time based on various vehicle parameters. The method includes providing a plurality of inputs that identify operating conditions of the fuel cell system and determining a maximum allowable start-time of the fuel cell system using a hybridization control strategy and the plurality of inputs. The method then determines a maximum compressor speed and ramp rate rate to provide the optimal start-time of the fuel cell system minimizing energy consumption and noise.

Additional features of the present invention will become apparent from the following description and appended claims, taken in conjunction with the accompanying drawings.

### BRIEF DESCRIPTION OF THE DRAWINGS

FIG. 1 is a simple block diagram of a fuel cell system; and

FIG. 2 is a flow type diagram showing a process for selecting compressor speed and ramp rate.

### DETAILED DESCRIPTION OF THE EMBODIMENTS

The following discussion of the embodiments of the invention directed to a system and method for optimizing a fuel cell system start-time based on various system input parameters is merely exemplary in nature, and is in no way intended to limit the invention or its applications or uses. For example, the present invention has particular application for a fuel cell system on a vehicle. However, as well be appreciated by those skilled in the art, the system and method of the invention may have application for other fuel cell systems.

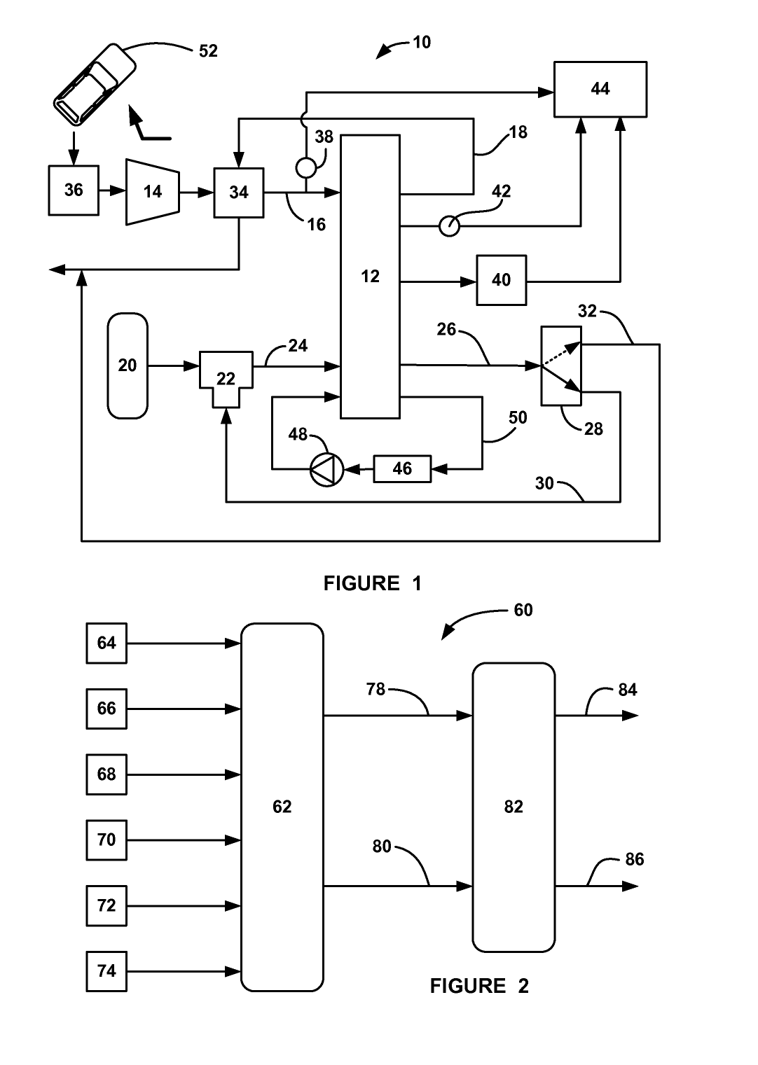

FIG. 1 is a simple block diagram of a fuel cell system 10 including a fuel cell stack 12 on, for example, a vehicle 52. A compressor 14 provides an airflow received from an air flow meter 36 that measures the air flow to the cathode side of the fuel cell stack 12 on a cathode input line 16 through a water vapor transfer (WVT) unit 34 that humidifies the cathode input air. A cathode exhaust gas is output from the stack 12 on a cathode exhaust gas line 18 that directs the cathode exhaust gas to the WVT unit 34 to provide the humidity to humidify the cathode input air. An RH sensor 38 is provided in the cathode input line 16 to provide an RH measurement of the cathode input airflow after it has been humidified by the WVT unit 34. A temperature sensor 42 is provided as a general representation of one or more temperature sensors that may be employed in the system 10 that are operable to obtain the temperature of the fuel cell stack 12 and/or various fluid flow regions in the system 10.

The fuel cell system 10 also includes a source 20 of hydrogen fuel or gas, typically a high pressure tank, that provides hydrogen gas to an injector 22 that injects a controlled amount of the hydrogen gas to the anode side of the fuel cell stack 12 on an anode input line 24. Although not specifically shown, one skilled in the art would understand that various pressure regulators, control valves, shut-off valves, etc. would be provided to supply the high pressure hydrogen gas from the source 20 at a pressure suitable for the injector 22. The injector 22 can be any injector suitable for the purposes discussed herein. One example is an injector/ejector as described in U.S. Pat. No. 7,320,840, titled, Combination of Injector/Ejector for Fuel Cell Systems, issued Jan. 22, 2008, assigned to the assignee of this application and herein incorporated by reference.

An anode effluent output gas is output from the anode side of the fuel cell stack 12 on an anode output line 26, which is provided to a bleed valve 28. As is well understood by those skilled in the art, nitrogen cross-over from the cathode side of the fuel cell stack 12 dilutes the hydrogen gas in the anode side of the stack 12, thereby affecting fuel cell stack performance. Therefore, it is necessary to periodically bleed the anode effluent gas from the anode sub-system to reduce the amount of nitrogen therein. When the system 10 is operating in a normal non-bleed mode, the bleed valve 28 is in a position where the anode effluent gas is provided to a recirculation line 30 that recirculates the anode gas to the injector 22 to operate it as an ejector and provide recirculated hydrogen gas back to the anode input of the stack 12. When a bleed is commanded to reduce the nitrogen in the anode side of the stack 12, the bleed valve 28 is positioned to direct the anode effluent gas to a by-pass line 32 that combines the anode effluent gas with the cathode exhaust gas on the line 18, where the hydrogen gas is diluted to be suitable for the environment. Although the system 10 is an anode recirculation system, the present invention will have application for other types of fuel cell systems including anode flow shift-systems, as would be well understood by those skilled in the art.

The fuel cell system 10 also includes an HFR circuit 40 that determines stack membrane humidity of the membranes in the stack 12 in a manner that is well understood by those skilled in the art. The HFR circuit 40 determines the high frequency resistance of the fuel cell stack 12 that is then used to determine the water content of the cell membranes within fuel cell stack 12. The HFR circuit 40 operates by determining the ohmic resistance, or membrane protonic resistance, of the fuel cell stack 12. Membrane protonic resistance is a function of membrane humidification of the fuel cell stack 12.

The fuel cell system 10 also includes a cooling fluid flow pump 48 that pumps a cooling fluid through flow channels within the stack 12 and a cooling fluid loop 50 outside of the stack 12. A radiator 46 reduces the temperature of the cooling fluid flowing through the loop 50 in a manner well understood by those skilled in the art. The fuel cell system 10 also includes a controller 44 that controls the operation of the system 10.

The present invention proposes a strategy for determining the maximum allowable start time and fuel cell system power request when starting the fuel cell system 10 from, for example, a key-off mode or a stand-by mode. The strategy looks at several vehicle operating parameters, such as vehicle speed, torque request, torque request history, system temperature, etc., to determine an optimum start-up time that considers system efficiency, power request and compressor noise. The desired start-up time can be used to calculate a desired cathode air flow rate from the compressor 14 during the system start. When slow system starts will not affect the drivability of the vehicle 52, lower cathode flow rates and compressor ramp rates can be used during the start to improve efficiency and reduce noise. When fast starts are required, then higher cathode flow rates are used at the expense of efficiency. The calculations to determine the desired start time can employ multi-variant expressions, a logic tree, multi-dimensional calibration tables, etc.

FIG. 2 is a control process flow block diagram 60 illustrating an optimization or hybridization strategy of the type discussed above, which can be part of the controller 44. Box 62 represents a hybridization strategy control algorithm, and receives various inputs, such as, for example, from a brake pedal position switch 64, an accelerator pedal position sensor 66, a gear selector position sensor 68, an ignition key position sensor 70, a vehicle speed sensor 72 and a battery state-of-charge calculation 74. These non-limiting inputs provide a number of conditions that could directly affect how fast the system 10 needs to be started, such as whether the brake of the vehicle 52 is on, whether the accelerator pedal is being pressed, whether the vehicle 52 is in drive or park, whether the start is from a key turn on or the system is already on, whether the vehicle 52 is currently moving, and whether there is battery power to help satisfy high power demands. The strategy control algorithm 62 considers driver requested vehicle start events, such as ignition key turn, remote start, proximity key, etc., and non-driver related start events, such as stand-by mode, restart, auto start, etc.

Each of these inputs and parameters is provided to the hybridization strategy control algorithm 62 that determines whether a slow system start time can be used or a fast system start time is required. Each of the input parameters can be processed by the hybridization strategy control algorithm 52 for different vehicle control strategies for different vehicle operating conditions, such as a start from an off-state, a stand-by mode, start-up by system controls, such as auto start or freeze start, remote key fob start, etc., and be weighted accordingly for that strategy. One of skill in the art would recognize various testing operations that could be used to optimize the start time for the particular fuel cell system.

For example, if the strategy control algorithm 62 determines that the accelerator pedal position is requesting 100% torque, the algorithm 62 will recognize that the fuel cell system power needs to be provided as quickly as possible to satisfy the request for vehicle acceleration, where parasitic losses and compressor noise would not be a concern. Conversely, if the hybridization strategy control algorithm 62 determines that the vehicle gear selector is in park, then a slower fuel cell system start-up time may be acceptable that would reduce parasitic losses and provide a quieter start up.

The hybridization strategy control algorithm 62 looks at all of the data available and from that performs a predetermined function, such as multi-variant expressions, a polynomial function, a logic tree, multi-dimensional calibration tables, truth table logic, etc., to determine the maximum allowable start time of the system 10, which is provided on line 78, and the requested system power immediately after start-up, which is provided on line 80. The maximum allowable start time and the requested stack power are provided to an energy consumption and noise optimization algorithm represented by box 82 that calculates a maximum compressor speed and flow, which is provided on line 84, based on the maximum start time by knowing the performance of the compressor 14, the volume of the cathode, the ambient air temperature, etc.

The energy consumption and noise optimization algorithm 82 can also calculate the compressor speed ramp rate at start-up, i.e., how fast the compressor 14 will increase in speed, also based on the maximum allowable compressor start time and the power request, which is provided on line 86. For example, the compressor ramp rate can be selectively controlled so that there are not sudden changes in the compressor speed that may occur as a result of the compressor 14 getting to a start-up flow delivery state, but then immediately require less air when the system 10 enters the run state after the start-up mode. The power request signal has a specific influence on what compressor ramp rate should be if the power request is low. The intent is to limit fast compressor speed changes which provide a significant audible event.

The hybridization strategy control algorithm 62 can reduce start times for those conditions where fast powertrain response is required. If the vehicle 52 is in stand-by mode, the compressor 14 may or may not be spinning prior to receiving a restart request. Examples of those start times include 1.4 seconds for a start from stand-by mode when the compressor 14 is stopped and 0.9 seconds for when the compressor 14 is spinning. When the vehicle 52 is started from the off-state, about 6 seconds for a key-on start from that state is generally required. Depending on the start time required based on the inputs discussed above, those minimum times can be increased accordingly, so that drivability requirements are met, but where efficiency and compressor noise is addressed to the extent possible.

Based on the discussion above, a number of implementations can be recognized. For example, a slow, quiet, efficient stand-by-to-run transition when a fast start is not required, for example, non-driver initiated restarts from stand-by mode when the fuel cell system is restarting to maintain operating temperature, high voltage battery needs charging, auto start for freeze warm-up, etc. Similarly, a slow, quiet efficient start-up is possible even when initiated by the driver when a fast start-time is not required, such as remote start initiated start-up, start from off state when the system is warm, etc. In these cases, the noise levels outside the vehicle are important. When utilizing the control strategy discussed above, fuel economy benefits can be measured when lower cathode flow rates are used during start-up from an off-state and a stand-by mode.

As discussed, the present invention provides a trade-off between drivability and efficiency thereby increasing system efficiency overall at no added cost. There are several noise benefits for implementing the invention. For example, start-up events are performed when the vehicle 52 is at a standstill involve no masking noises, such as tire and air noise, so powertrain generated noises are more noticeable. For standstill start events, reduction to the noise related to start-up will improve the customer experience. Further, the invention provides a mechanism to implement a good balance between restart noise level verses driver input expectations. Non-driver events should be as quiet as possible, i.e., the driver did not turn the key to start, shift out of park, push on the accelerator pedal, etc.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for controlling a start time of a fuel cell system, said system including a fuel cell stack having a cathode side and a compressor providing air to the cathode side of the fuel cell stack, said method comprising:
providing a plurality of inputs that identify operating conditions of the fuel cell system;
determining a maximum allowable start time of the fuel cell system using a hybridization control strategy and the plurality of inputs; and
determining a maximum compressor speed and airflow to provide the maximum allowable start-time of the fuel cell system using an energy consumption and noise optimization strategy.

2. The method according to claim 1 wherein the fuel cell system is a vehicle fuel cell system.

3. The method according to claim 2 wherein the plurality of inputs include a brake pedal switch position, an accelerator pedal position, a gear selector position, an ignition key position vehicle speed and available battery power.

4. The method according to claim 1 wherein determining a maximum compressor speed and airflow to provide the maximum allowable start-time of the fuel cell system includes considering compressor noise and compressor parasitic power consumption when determining the maximum compressor speed and flow.

5. The method according to claim 1 further comprising determining a compressor speed/flow ramp rate using the energy consumption and noise optimization strategy to provide the maximum allowable start-time of the fuel cell system.

6. The method according to claim 1 wherein the method controls the start time from a stand-by mode.

7. The method according to claim 1 wherein the method controls the start time from a vehicle key-on start.

8. The method according to claim 1 wherein the method controls the start time from an auto start or a remote key fob start.

9. The method according to claim 1 wherein determining a maximum allowable start time of the fuel cell system using a hybridization control strategy includes using a function selected from the group consisting of multi-variant expressions, logic trees and multi-dimensional calibration tables.

10. A method for controlling a start time of a fuel cell system on a vehicle, said system including a fuel cell stack having a cathode side and a compressor providing air to the cathode side of the fuel cell stack, said method comprising:
providing a plurality of inputs that identify operating conditions of the fuel cell system, wherein the plurality of inputs include a brake pedal switch position, an accelerator pedal position, a gear selector position, an ignition key position vehicle speed and available battery power;
determining a maximum allowable start time of the fuel cell system using a hybridization control strategy and the plurality of input; and
determining a maximum compressor speed and airflow to provide the maximum allowable start-time of the fuel cell system using an energy consumption and noise optimization strategy, wherein determining a maximum compressor speed and airflow to provide the maximum allowable start-time of the fuel cell system includes considering compressor noise and compressor parasitic power consumption when determining the maximum compressor speed and flow.

11. The method according to claim 10 further comprising determining a compressor speed/flow ramp rate using the energy consumption and noise optimization strategy to provide the maximum allowable start-time of the fuel cell system.

12. The method according to claim 10 wherein the method controls the start time from a vehicle key-on start, a stand-by mode, auto start or remote key fob start.

13. The method according to claim 10 wherein determining a maximum allowable start time of the fuel cell system using a hybridization control strategy includes using a function selected from the group consisting of multi-variant expressions, logic trees and multi-dimensional calibration tables.

14. A control system for controlling a start time of a fuel cell system on a vehicle, said fuel cell system including a fuel cell stack having a cathode side and a compressor providing air to the cathode side of the fuel cell stack, said control system comprising:
means for providing a plurality of inputs that identify operating conditions of the fuel cell system;
means for determining a maximum allowable start time of the fuel cell system using a hybridization control strategy and the plurality of input; and
means for determining a maximum compressor speed and airflow to provide the maximum allowable start-time of the fuel cell system using an energy consumption and noise optimization strategy.

15. The control system according to claim 14 wherein the plurality of inputs include a brake pedal switch position, an accelerator pedal position, a gear selector position, an ignition key position vehicle speed and available battery power.

16. The control system according to claim 14 wherein the means for determining a maximum compressor speed and airflow to provide the maximum allowable start-time of the fuel cell system considers compressor noise and compressor parasitic power consumption when determining the maximum compressor speed and flow.

17. The control system according to claim 14 further comprising means for determining a compressor speed/flow ramp rate using the energy consumption and noise optimization strategy to provide the maximum allowable start-time of the fuel cell system.

18. The control system according to claim 14 wherein the method controls the start time from a stand-by mode.

19. The control system according to claim 14 wherein the control system controls the start time from a vehicle key-on start.

20. The control system according to claim 14 wherein the means for determining a maximum allowable start time of the fuel cell system using a hybridization control strategy uses a function selected from the group consisting of multi-variant expressions, logic trees and multi-dimensional calibration tables.
